(19) United States
(12) Patent Application Publication
(10) Pub. No.: US 2002/0174226 A1
(43) Pub. Date: Nov. 21, 2002

(54) Communications channel reservation in computer network telephony systems

(76) Inventors: Michael Fortinsky, Raanana (IL); Dmitri Pikus, Herzlia (IL); Vladimir Pogrebinsky, Issaquah, WA (US)

Correspondence Address: KATTEN MUCHIN ZAVIS ROSENMAN, 575 MADISON AVENUE, NEW YORK, NY, 10022-2585, US

(21) Appl. No.: 09/860,034

(22) Filed: May 17, 2001

(51) Int. Cl. G06F 15/173

(52) U.S. Cl. 709/226

(57) ABSTRACT

A method for communications channel reservation in a computer network telephony system, the method including a) a local gateway sending a resource reservation request to a local gatekeeper for at least one remote telephone line, b) the local gatekeeper sending the resource reservation request to a remote gatekeeper via a network, c) the remote gatekeeper querying a remote gateway to determine if the remote gateway has any telephone lines that the remote gateway may provide for the termination of telephone calls, d) the remote gatekeeper reserving for the local gatekeeper in response to the reservation request at least one terminatable telephone line at the remote gateway, e) the remote gatekeeper notifying the local gatekeeper of the reservation for the local gatekeeper, and f) the local gatekeeper forwarding information regarding the reservation to the local gateway.

### FIELD OF INVENTION

The present invention relates to computer network telephony in general, and more particularly to communications channel management in computer network telephony systems.

### BACKGROUND OF THE INVENTION

Computer network telephony protocols, such as H.323, SIP, and MGCP, specify the components, protocols, and procedures providing for the transmission of real-time audio, video, multimedia, and data communications over packet-based networks, such as the Internet. One of the primary goals of computer network telephony protocols is interoperability of disparate networks, such as a computer network with a Public Switched Telephone Network (PSTN). This interoperability is often achieved through the use of a “gateway” which performs network and signaling translation between disparate networks.

The H.323 protocol, for example, specifies four kinds of components, which, when networked together, provide point-to-point and point-to-multpoint multimedia-communication services:

terminals

gateways

gatekeepers

multipoint control units MCUs).

A terminal is typically used by the end user for audio, video, and/or data input and/or output. A terminal is typically a personal computer (PC) or a stand-alone device.

A gateway connects two dissimilar networks, such as the Internet and a PSTN, in which case the gateway typically has a finite number of PSTN lines, the availability of which often varies at different times.

A gatekeeper may provide addressing, authorization, and authentication services for terminals and gateways, as well as bandwidth management, accounting, billing, and call-routing services.

MCUs provide support for conferences of three or more terminals.

All terminals, gateways, and MCUs managed by a single gatekeeper define a “zone,” one or more of which are typically grouped into an “administrative domain” belonging to a single service provider.

Call signaling is generally performed in one of two modes: Gatekeeper Routed Call (GRC) mode and Direct Routed Call (DARC) mode. In GRC mode, signaling messages traverse the gatekeeper in the zone in which the call originates, the gatekeeper in the zone in which the call is to be terminated, or both gatekeepers. In DRC mode, an originating gateway or PC terminal sends signaling messages directly to a terminating gateway or PC terminal.

An exemplary H.323 interzone or interdomain telephony call between two PSTN terminals (i.e., a telephone) is initiated by an originating teal in a first zone A and handled by the local terminal's gateway. The zone A gateway then requests routing information from the zone A gatekeeper which in turn contacts the terminating gatekeeper in the destination zone B and requests routing information. The terminating gatekeeper finds a terminating gateway that can potentially terminate the call based on the terminating gatekeeper's knowledge of the availability of lines at each of its gateways, with his information typically being provided periodically by the gateways. The terminating gatekeeper determines which gateway can potentially provide both a physical telephone line as well as the necessary network connection from the potentially terminating gateway to the originating gateway or PC terminal at the time that the originating gatekeeper requests routing information. The terminating gatekeeper returns the network address of the potentially terminating gateway (in DRC mode) or its own address (in GRC mode) to the originating gatekeeper in zone A. The zone A gatekeeper then forwards the address to the zone A gateway which establishes the connection between the zone A gateway or PC terminal and the zone B gateway, either directly (in DRC mode) or via the originating and/or terminating gatekeeper (in CRC mode).

The above per-call line request and allocation method requires contacting the remote zone/domain for each and every call. Information about the specific call is provided and the remote zone/domain responds with information sufficient for terminating (connecting to a terminus) the specific call. While this method provides precise resource management; as the remote domain controls the load on its equipment deterministically, from the local terminal's perspective this method has the greatest post dial delay (PDD) since the call's termination is dependent on how the remote zone/domain responds, and there is no guarantee that termination resources will be available. Network traffic is also relatively high, since several messages (i.e., request and response) must be sent for each call.

In another method resources are requested and allocated for several calls simultaneously. In this method the remote zone/domain is contacted once for every several calls. The remote zone/domain responds with information sufficient for terminating several calls, typically for a limited time. While this method has less PDD than the previous method since not every call is delayed until the remote zone/domain responds, and network traffic is relatively low since request/respond messages are not sent for every call, this method suffers from poor resource management, since the remote zone/domain has no knowledge about whether and how multiple call authorizations are ultimately going to be used and what resources will ultimately be required. For example, all N authorized calls may be terminated simultaneously, in which case N free lines are used simultaneously, or alternatively, only one call at a tine may be terminated, in which case only a single free line is used at any given time.

In another method routing information about terminating gateways in a domain may be shared with other gatekeepers within the domain or zone as well as outside of the domain or zone. Thus, each gatekeeper may directly access this information and use it for terminating calls without prior authorization from the terminating gatekeeper. While this method also reduces PDD since calls are not delayed until the remote zone/domain responds to a resource allocation request, and network traffic is relatively low since only the shared routing information is sent to update the gatekeepers and not resource allocation requests themselves, this method also suffers from poor resource management, since the remote domain/zone has no knowledge regarding how other gatekeepers will use it for terminating their calls and what resources will be required, and only knows where to route certain calls when received. Thus, the number of resource allocation requests may exceed the amount of available resources, causing some of the call termination attempts to fail,

### SUMMARY OF THE INVENTING

The present invention seeks to provide a novel approach to resource allocation in a computer network telephony system in which reservation of remote resources, such as actual PSTN lines on the PSTN side of a gatekeeper, is made prior to, and therefore independent from, call requests. In the present invention a local gatekeeper requests from a gatekeeper in a remote zone/domain that one or more communications lines be reserved in advance for the local gatekeeper's use at a later time, typically for a specified time period. The present invention reduces post dial delay (PDD) since termination of call requests is not delayed until the remote zone/domain gatekeeper responds. Network traffic is reduced, since request/respond messages are not sent for every call and line reservation is requested only periodically and not in response to call requests. The present invention allows for precise resource management, since the remote zone/domain gatekeeper knows how many lines are allocated, to whom, and for how long.

There is thus provided in accordance with a preferred embodiment of the present invention a method for communications channel reservation in a computer network telephony system, the method including a) a local gateway sending a resource reservation request to a local gatekeeper for at least one remote telephone line, b) the local gatekeeper sending the resource reservation request to a remote gatekeeper via a network, c) the remote gatekeeper querying a remote gateway to determine if the remote gateway has any telephone lines that the remote gateway may provide for the termination of telephone calls, d) the remote gatekeeper reserving for the local gatekeeper in response to the reservation request at least one terminatable telephone line at the remote gateway, e) the remote gatekeeper noting the local gatekeeper of the reservation for the local gatekeepers and ) the local gatekeeper forwarding information regarding the reservation to the local gateway.

Further in accordance with a preferred embodiment of the present invention the sending a resource reservation request step a) includes sending a request for reserving resources for a reservation period.

Still further in accordance with a preferred embodiment of the present invention the sending a resource reservation request step a) includes sending a request for reserving resources for a reservation period specifying an amount of time starting from the time the request is made.

Additionally in accordance with a preferred embodiment of the present invention the sending a resource reservation request step a) includes sending a request for reserving resources for a reservation period specifying a time of day.

Moreover in accordance with a preferred embodiment of the present invention the querying step c) includes querying the remote gateway in response to receiving the request from the local gatekeeper.

Further in accordance with a preferred embodiment of the present invention the querying step c) includes periodically querying the remote gateway.

Still further in accordance with a preferred embodiment of the present invention the reserving step d) includes reserving for an actual reservation period not exceeding the requested reservation period.

Additionally in accordance with a preferred embodiment of the present invention the reserving step d) includes reserving where the telephone line has not been previously reserved for a period that at least partly overlaps the actual reservation period.

Moreover in accordance with a preferred embodiment of the present invention the notifying step e) includes notifyig the local gatekeeper of the actual reservation period.

Further in accordance with a preferred embodiment of We present invention the method further includes a terminal sending a call termination request to the local gateway, the local gateway connecting to the remote gateway where the telephone line is reserved for the local gateway and forwarding the call termination request to the remote gateway, and the remote gateway terminating the call via the reserved telephone line.

Still further in accordance with a preferred embodiment of the present invention the method further includes a terminal sending a call termination request to the local gateway during the actual reservation period, the local gateway connecting to the remote gateway where the telephone line is reserved during the actual reservation period for the local gateway and forwarding the call termination request to the remote gateway, and the remote gateway terminating the call via the reserved telephone line.

Additionally in accordance with a preferred embodiment of the present invention the local gateway is a network-telephony enabled PC.

Moreover in accordance with a preferred embodiment of the present invention the local gateway is operative to function as a terminal.

Further in accordance with a preferred embodiment of the present invention the noting step e) includes the remote gatekeeper providing to the local gatekeeper 1) the network address of the remote gateway and 2) the number of the telephone lines that have been reserved for the local gatekeeper at the remote gateway.

Still further in accordance with a preferred embodiment of the present invention the notifying step e) includes the remote gatekeeper providing to the local gatekeeper 1) the number of the telephone lines that have been reserved for the local gatekeeper.

Additionally in accordance with a preferred embodiment of the present invention the notifying step e) further includes the remote gatekeeper providing to the local gatekeeper 1) the address of the terminating gatekeeper.

Moreover in accordance with a preferred embodiment of the present invention the method further includes a terminal sending a call termination request to the local gateway, the local gateway connecting to either of the local gatekeeper and the remote gatekeeper and forwarding the call termination request thereto, and the remote gatekeeper effecting the call termination via the reserved telephone line at the remote gateway.

Further in accordance with a preferred embodiment of the present invention the notifying step e) includes the remote gatekeeper providing to the local gatekeeper 1) the network address of the remote gateway, 2) the number of the telephone lines that have been reserved for the local gatekeeper at the remote gateway, and 3) the actual reservation period for each of the reserved telephone lines.

Still further in accordance with a preferred embodiment of the present invention the notifying step e) includes the remote gatekeeper providing to the local gatekeeper 1) the number of the telephone lines that have been reserved for the local gatekeeper and 2) the actual reservation period for each of the reserved telephone lines.

Additionally in accordance with a preferred embodiment of the present invention the notifying step e) further includes the remote gatekeeper providing to the local gatekeeper 1) the address of the terminating gatekeeper.

Moreover in accordance with a preferred embodiment of the present invention the method firer includes a terminal sending a call termination request to the local gateway, the local gateway connecting to either of the local gatekeeper and the remote gatekeeper and forwarding the call termination request thereto, and the remote gatekeeper effecting the call termination via the reserved telephone line at the remote gateway.

There is also provided in accordance with a preferred embodiment of the present invention a method for communications channel reservation in a computer network telephony system, the method including c) querying a remote gateway to determine if the remote gateway has any telephone lines that the remote gateway may provide for the termination of telephone calls, and d) reserving at least one terminatable telephone line at the remote gateway,

Further in accordance with a preferred embodiment of the present invention the method further includes a) a local gateway sending a resource reservation request to a local gatekeeper for at least one remote telephone line, and b) the local gatekeeper sending the resource reservation request to a remote gatekeeper via a network, and the querying step c) and the reserving step d) are performed by the remote gatekeeper, and S the reserving step d) includes reserving in response to receiving the resource reservation request.

Still further in accordance with a preferred embodiment of the present invention the querying step c) and the reserving step d) are performed by a remote gatekeeper, and the method fisher includes e) the remote gatekeeper notifying a local gatekeeper of the reservation, and f) the local gatekeeper forwarding information regarding the reservation to a local gateway.

Additionally in accordance with a preferred embodiment of the present invention the sending a resource reservation request step a) includes sending a request for reserving resources for a reservation period.

Moreover in accordance with a preferred embodiment of the present invention the sending a resource reservation request step a) includes sending a request for reserving resources for a reservation period specifying an amount of time starting from the time the request is made.

Further in accordance with a preferred embodiment of the present invention the sending a resource reservation request step a) includes sending a request for reserving resources for a reservation period specifying a time of day.

Still further in accordance with a preferred embodiment of the present invention the querying step c) includes querying the remote gateway in response to receiving the request from the local gatekeeper.

Additionally in accordance with a preferred embodiment of the present invention the querying step c) includes periodically querying the remote gateway.

Moreover in accordance with a preferred embodiment of the present invention the reserving step d) includes reserving for an actual reservation period not exceeding the requested reservation period.

Further in accordance with a preferred embodiment of the present invention the reserving step d) includes reserving where the telephone line has not been previously reserved for a period that at least partly overlaps the actual reservation period.

Still further in accordance with a preferred embodiment of the present invention the notifying step e) includes notifying the local gatekeeper of the actual reservation period.

Additionally in accordance with a preferred embodiment of the present invention the method further includes a terminal sending a call termination request to the local gateway, the local gateway connecting to the remote gateway where the telephone line is reserved for the local gateway and forwarding the call termination request to the remote gateway, and the remote gateway terminating the call via the reserved telephone line.

Moreover in accordance with a preferred embodiment of the present invention the method further includes a terminal sending a call termination request to the local gateway during the actual reservation period, the local gateway connecting to the remote gateway where the telephone line is reserved during the actual reservation period for the local gateway and forwarding the call termination request to the remote gateway, and the remote gateway terminating the call via the reserved telephone line.

Further in accordance with a preferred embodiment of the present invention the local gateway is a network-telephony enabled PC.

Still further in accordance with a preferred embodiment of the present invention the local gateway is operative to function as a terminal.

Additionally in accordance with a preferred embodiment of the present invention the notifying step e) includes the remote gatekeeper providing to the local gatekeeper ) the network address of the remote gateway and ) the number of the telephone lines that have been reserved for the local gatekeeper at the remote gateway.

Moreover in accordance with a preferred embodiment of the present invention the notifying step e) includes the remote gatekeeper providing to the local gatekeeper 1) the number of the telephone lines that have been reserved for the local gatekeeper.

Further in accordance with a preferred embodiment of the present invention the not g step e) further includes the remote gatekeeper providing to the local gatekeeper 1) the address of the terminating gatekeeper.

Still further in accordance with a preferred embodiment of the present invention the method further includes a terminal sending a call termination request to the local gateway, the local gateway connecting to either of the local gatekeeper and the remote gatekeeper and forwarding the call termination request thereto, and the remote gatekeeper effecting the call termination via the reserved telephone line at the remote gateway.

Additionally in accordance with a preferred embodiment of the present invention the notifying step e) includes the remote gatekeeper providing to the local gatekeeper 1) the network address of the remote gateway, 2) the number of the telephone lines that have been reserved for the local gatekeeper at the remote gateway, and 3) the actual reservation period for each of the reserved telephone lines.

Moreover in accordance with a preferred embodiment of the present invention the notifying step e) includes the remote gatekeeper providing to the local gatekeeper 1) the number of the telephone lines that have been reserved for the local gatekeeper and 2) the actual reservation period for each of the reserved telephone lines.

Further in accordance with a preferred embodiment of the present invention the notifying step e) further includes the remote gatekeeper providing to the local gatekeeper 1) the address of the terminating gatekeeper.

Still further in accordance with a preferred embodiment of the present invention the method further includes a terminal sending a call termination request to the local gateway, the local gateway connecting to either of the local gatekeeper and the remote gatekeeper and forwarding the call termination request thereto, and the remote gatekeeper effecting he call termination via the reserved telephone line at the remote gateway.

The disclosures of all patents, patent applications, and other publications mentioned in this specification and of the patents, patent applications, and other publications cited therein are hereby incorporated by reference.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a computer network telephony system in a resource reservation mode for PSTN terminal to PSTN terminal communications, constructed and operative in accordance with a preferred embodiment of the present invention;

FIG. 2 is a simplified flowchart illustration of a method of operation of the system of FIG. 1, operative in accordance with a preferred embodiment of the present invention;

FIG. 3 is a simplified conceptual illustration of a computer network telephony system in a call request mode, constructed and operative in accordance with a preferred embodiment of the present invention; and

FIG. 4 is a simplified flowchart illustration of a method of operation of the system of FIG. 3, operative in accordance with a preferred embodiment of the present invention.

### DETAILED DESCRIPTION OF PREFERRED EMBODIMENTS

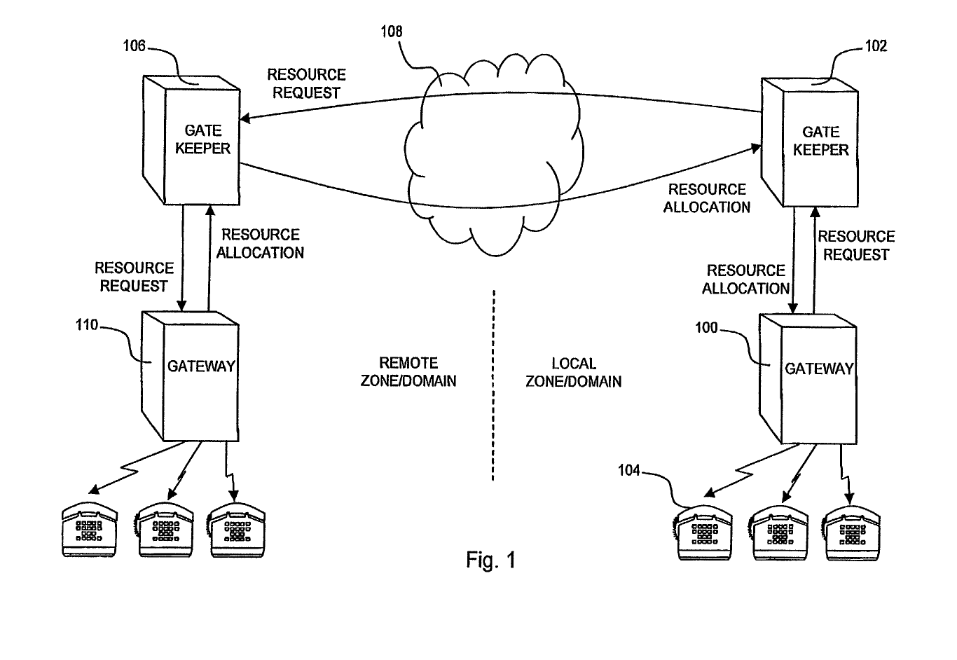

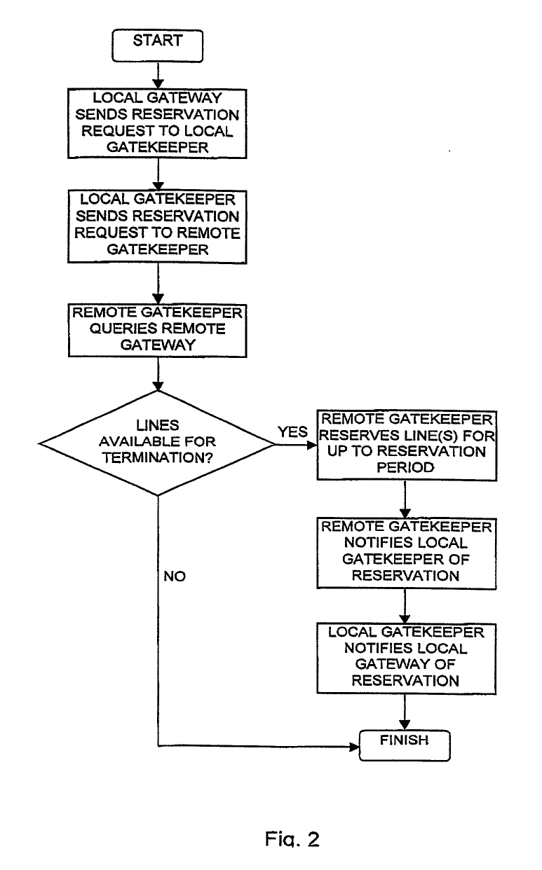

Reference is now made to FIG. 1, which is a simplified conceptual illustration of a computer network telephony system in a resource reservation mode for PSTN terminal to PSTN terminal communications, constructed and operative in accordance with a preferred embodiment of the present invention, and additionally to FIG. 2, which is a simplified flowchart illustration of a method of operation of the system of FIG. 1, operative in accordance with a preferred embodiment of the present invention. In the system of FIG. 1 and method of FIG. 2, a gateway 100 in a local zone/domain sends a resource reservation request to a gatekeeper 102 in the same zone/domain for one or more telephone lines in a remote zone/domain to be reserved for gateway 100's use for termination of calls at the remote zone/domain, typically for a specified period of time, hereinafter referred to as the reservation period. The reservation period may specify an amount of time starting from the time the request is made, such as “the next three hours,” or, alternatively, may specify a time of day, such as “between 3 pm and 4 pm.” Gateway 100 preferably makes its request based on a statistical analysis of historical call requests during various time periods that are placed by one or more terminals 104 connected to and serviced by gateway 100 to the remote domain in question. Alternatively, gatekeeper 102 may determine its own needs for communications lines independently, prior to receiving such requests by gateway 100, also by using statistical analysis techniques. Gatekeeper 102 then sends the resource reservation request to a gatekeeper 106 in the remote zone/domain via a network 108, such as the Internet.

Gatekeeper 106 queries a gateway 110 to determine if gateway 110 has any telephone lines that are currently available and that gateway 110 may provide for the termination of telephone calls. The distinction between “currently available” telephone lines at gateway 110 and telephone lines that may be provided at gateway 110 for the termination of telephone calls refers to the situation where the total number of telephone lines physically connected to gateway 110 may be greater than the total number of calls that gateway 110 may actually terminate due to limitations such as the number of computer network connections available to gateway 110 and/or limited processing power. Gatekeeper 106 may query gateway 110 for this information in response to the request from gatekeeper 102 and/or may periodically query gateway 110 for such information. Of the number of currently available and terminatable telephone lines at gateway 110, gatekeeper 106 may reserve up to the number of telephone lines requested by gatekeeper 102 for an actual reservation period of up to the reservation period requested by gatekeeper 102, provided that the telephone lines have not been previously reserved for a reservation period that coincides with or overlaps the actual reservation period, which information is preferably maintained by gatekeeper 106. Gatekeeper 106 then notifies gatekeeper 102 of the number of telephone lines reserved for its use and of the actual reservation period granted, in addition to the network address or other connectivity identification of gateway 110. Gatekeeper 102 then typically forwards this information to gateway 100. It is appreciated that the resource request from the local zone/domain need not necessarily coincide with the resource reservation request made at the remote zone/domain between gatekeeper 106 and gateway 110.

The total number of telephone lines connected to gateway 110, the total number of telephone calls that gateway 110 may actually terminate via these telephone lines, as well as the number of non-operational telephone lines, may be stored at gatekeeper 106 and/or reported by gateway 110 to gatekeeper 106 periodically or in response to a query.

In a preferred implementation, particularly useful for reservation periods expressed as an amount of time from the time the reservation request is made, gatekeeper 106 maintains three pools of telephone line information for gateway 110 as follows:

1. A pool (a) of telephone lines currently available for reservation;

2. A pool (b) of reserved telephone lines and their granted reservation periods; and

3. A pool (c) of telephone lines that are currently non-operational.

When a reservation for a telephone line is made, the reserved telephone line is taken from pool (a) and transferred to pool (b) along with the granted reservation period. When the granted reservation period has elapsed for a reserved telephone line in pool (b), the line is transferred from pool (b) back to pool (a). When a report is received from gateway 110 indicating that a telephone line is non-operational, the telephone line is transferred from pool (a) to pool (c). When a report is received from gateway 110 indicating that a telephone line has become operational, the telephone line is transferred from pool (c) to pool (a).

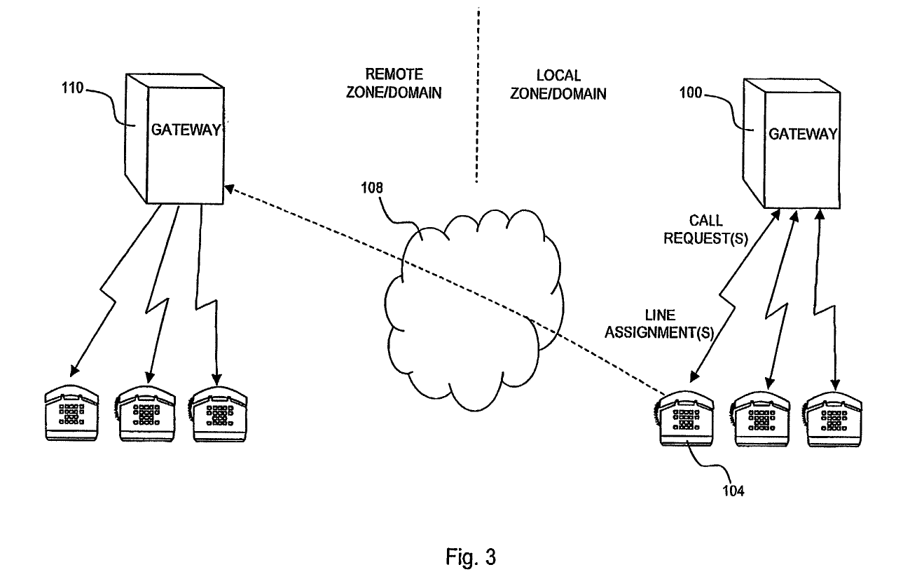

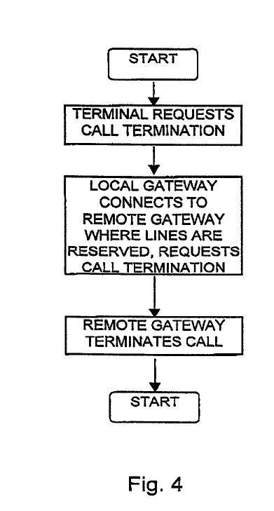

Reference is now made to FIG. 3, which is a simplified conceptual illustration of a computer network telephony system in a call request mode, constructed and operative in accordance with a preferred embodiment of the present invention, and additionally to FIG. 4, which is a simplified flowchart illustration of a method of operation of the system of FIG. 3, operative in accordance with a preferred embodiment of the present invention. In the system of FIG. 3 and method of FIG. 4, once the resource reservation has been made. i.e., the reservation of communications lines at the remote zone/domain has been made, gateway 100 receives from terminals 104 one or more requests for call termination at the remote zone/domain during the granted reservation period. Gateway 100 then, using conventional techniques, connects to remote gateway 110 using its network address or other connectivity identification, as gateway 100 knows gateway 110 has resources reserved for it, and requests that the call be terminated at remote gateway 110. Remote gateway 110 then terminates the call via an appropriate reserved line. Termination is thus ensured with minimal post-dial delay.

It is appreciated that the systems and methods of FIGS. 1-4 may be adapted for PC terminal to PSTN terminal communications, where a single network-telephony enabled PC acts as both gateway and terminal, and incorporates the functionality of both gateway 100 and terminal 104 as described hereinabove.

In any of the above methods it is appreciated that more than one call may be assigned one after another to a given remote communication line during the reservation period, and that multiple simultaneous calls may be collectively terminated at any given time during the reservation period by a corresponding number of allocated communication lines relating to one or a number of remote gateways.

In any of the above methods, where call signaling is to be performed in DRC mode, the terminating gatekeeper may return to the originating gatekeeper one or more sets of parameters, each set including 1) the network address of a gateway, 2) the number of telephone lines that have been reserved for the originating gatekeeper at the gateway, and 3) the reservation time for each reserved line. The originating gatekeeper then passes this information to the originating gateway, such as where the originating terminal is a telephone, or to the originating terminal, such as where the originating terminal is a PC. Thereafter, when the originating teal attempts to make a call, it may contact the terminating gateway directly without the intervention of either the originating or terminating gatekeepers.

Alternatively, where call signaling is to be performed in GRC mode, the terminating gatekeeper may return to the originating gatekeeper a single set of parameters including 1) the number of telephone lines that have been reserved for the originating gatekeeper, 2) the reservation time for each reserved line and, optionally, 3) the address of the terminating gatekeeper, such as where the terminating gatekeeper that is contacted by the originating gatekeeper is not the terminating gatekeeper that will ultimately route the call. It should be noted that the originating gateway is unaware of the exact telephone line reservations per terminating gateway, yet merely knows the total number of reserved lines. Thereafter, when the originating terminal attempts to make a call, signaling requests are sent by the originating terminal (e.g., if it is a PC). the originating gateway, or the originating gatekeeper to the terminating gatekeeper which forwards them to an appropriate terminating gateway at which a telephone line has been reserved for the originating side.

It is appreciated that one or more steps of any of the methods described herein may be implemented in a different order than that shown while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for communications channel reservation in a computer network telephony system, the method comprising:
a) a local gateway sending a resource reservation request to a local gatekeeper for at least one remote telephone line;
b) said local gatekeeper sending said resource reservation request to a remote gatekeeper via a network;
c) said remote gatekeeper querying a remote gateway to determine if said remote gateway has any telephone lines that said remote gateway may provide for the termination of telephone calls;
d) said remote gatekeeper reserving for said local gatekeeper in response to said reservation request at least one terminatable telephone line at said remote gateway;
e) said remote gatekeeper notifying said local gatekeeper of said reservation for said local gatekeeper; and
f) said local gatekeeper forwarding information regarding said reservation to said local gateway.

2. A method according to claim 1 wherein said sending a resource reservation request step a) comprises sending a request for reserving resources for a reservation period.

3. A method according to claim 2 wherein said sending a resource reservation request step a) comprises sending a request for reserving resources for a reservation period specifying an amount of time starting from the time the request is made.

4. A method according to claim 2 wherein said sending a resource reservation request step a) comprises sending a request for reserving resources for a reservation period specifying a time of day.

5. A method according to claim 1 wherein said querying step c) comprises querying said remote gateway in response to receiving said request from said local gatekeeper.

6. A method according to claim I wherein said querying step c) comprises periodically querying said remote gateway.

7. A method according to claim 2 wherein said reserving step d) comprises reserving for an actual reservation period not exceeding said requested reservation period.

8. A method according to claim 7 wherein said reserving step d) comprises reserving where said telephone line has not been previously reserved for a period that at least partly overlaps said actual reservation period.

9. A method according to claim 7 wherein said notifying step e) comprises notifying said local gatekeeper of said actual reservation period.

10. A method according to claim 1 and further comprising.
a terminal sending a call termination request to said local gateway;
said local gateway connecting to said remote gateway where said telephone line is reserved for said local gateway and forwarding said call termination request to said remote gateway; and
said remote gateway terminating said call via said reserved telephone line.

11. A method according to claim 7 and further comprising.
a terminal sending a call termination request to said local gateway during said actual reservation period;
said local gateway connecting to said remote gateway where said telephone line is reserved during said actual reservation period for said local gateway and forwarding said call termination request to said remote gateway; and
said remote gateway terminating said call via said reserved telephone line.

12. A method according to claim 1 wherein said local gateway is a network-telephony enabled PC.

13. A method according to claim 12 wherein said local gateway is operative to function as a terminal.

14. A method according to claim 1 wherein said notifying step e) comprises said remote gatekeeper providing to said local gatekeeper 1) the network address of said remote gateway and 2) the number of said telephone lines that have been reserved for said local gatekeeper at said remote gateway.

15. A method according to claim 1 wherein said notifying step e) comprises said remote gatekeeper providing to said local gatekeeper 1) the number of said telephone lines that have been reserved for said local gatekeeper.

16. A method according to claim 15 wherein said notifying step e) further comprises said remote gatekeeper providing to said local gatekeeper 3) the address of the terminating gatekeeper.

17. A method according to claim 15 and further comprising:
a terminal sending a call termination request to said local gateway;
said local gateway connecting to either of said local gatekeeper and said remote gatekeeper and forwarding said call termination request thereto; and
said remote gatekeeper effecting said call termination via said reserved telephone line at said remote gateway.

18. A method according to claim 7 wherein said notifying step e) comprises said remote gatekeeper providing to said local gatekeeper 1) the network address of said remote gateway, 2) the number of said telephone lines that have been reserved for said local gatekeeper at said remote gateway, and 3) the actual reservation period for each of said reserved telephone lines.

19. A method according to claim 7 wherein said notifying step e) comprises said remote gatekeeper providing to said local gatekeeper 1) the number of said telephone lines that have been reserved for said local gatekeeper and 2) the actual reservation period for each of said reserved telephone lines.

20. A method according to claim 19 wherein said notifying step e) further comprises said remote gatekeeper providing to said local gatekeeper 3) the address of the terminating gatekeeper.

21. A method according to claim 19 and further comprising:
a terminal sending a call termination request to said local gateway;
said local gateway connecting to either of said local gatekeeper and said remote gatekeeper and forwarding said call termination request thereto; and
said remote gatekeeper effecting said call termination via said reserved telephone line at said remote gateway.

22. A method for communications channel reservation in a computer network telephony system, the method comprising:
c) querying a remote gateway to determine if said remote gateway has any telephone lines that said remote gateway may provide for the termination of telephone calls; and
d) reserving at least one terminatable telephone line at said remote gateway.

23. A method according to claim 22 and further comprising:
a) a local gateway sending a resource reservation request to a local gatekeeper for at least one remote telephone line; and
b) said local gatekeeper sending said resource reservation request to a remote gatekeeper via a network,
and wherein said querying step c) and said reserving step d) are performed by said remote gatekeepers
and wherein said reserving step d) comprises reserving in response to receiving said resource reservation request.

24. A method according to claim 22 wherein said querying step c) and said reserving step d) are performed by a remote gatekeeper, and further comprising:
e) said remote gatekeeper notifying a local gatekeeper of said reservation; and
f) said local gatekeeper forwarding information regarding said reservation to a local gateway.

25. A method according to claim 23 wherein said sending a resource reservation request step a) comprises sending a request for reserving resources for a reservation period.

26. A method according to claim 25 wherein said sending a resource reservation request step a) comprises sending a request for reserving resources for a reservation period specifying an amount of time staring from the time the request is made.

27. A method according to claim 25 wherein said sending a resource reservation request step a) comprises sending a request for reserving resources for a reservation period specifying a time of day.

28. A method according to claim 23 wherein said querying step c) comprises querying said remote gateway in response to receiving said request from said local gatekeeper.

29. A method according to claim 22 wherein said querying step c) comprises periodically querying said remote gateway.

30. A method according to claim 25 wherein said reserving step d) comprises reserving for an actual reservation period not exceeding said requested reservation period.

31. A method according to claim 30 wherein said reserving step d) comprises reserving where said telephone line has not been previously reserved for a period that at least partly overlaps said actual reservation period.

32. A method according to claim 30 wherein said notifying step e) comprises notifying said local gatekeeper of said actual reservation period.

33. A method according to claim 24 and further comprising:
a terminal sending a call termination request to said local gateway;
said local gateway connecting to said remote gateway where said telephone line is reserved for said local gateway and forwarding said call termination request to said remote gateway; and
said remote gateway terminating said call via said reserved telephone line.

34. A method according to claim 30 and further comprising:
a terminal sending a call termination request to said local gateway during said actual reservation period;
said local gateway connecting to said remote gateway where said telephone line is reserved during said actual reservation period for said local gateway and forwarding said call termination request to said remote gateway; and
said remote gateway terminating said call via said reserved telephone line.

35. A method according to claim 23 wherein said local gateway is a network-telephony enabled PC.

36. A method according to claim 35 wherein said local gateway is operative to function as a terminal.

37. A method according to claim 24 wherein said noting step e) comprises said remote gatekeeper providing to said local gatekeeper 1) the network address of said remote gateway and 2) the number of said telephone lines that have been reserved for said local gatekeeper at said remote gateway.

38. A method according to claim 24 wherein said notifying step e) comprises said remote gatekeeper providing to said local gatekeeper 1) the number of said telephone lines that have been reserved for said local gatekeeper.

39. A method according to claim 38 wherein said notifying step e) further comprises said remote gatekeeper providing to said local gatekeeper 3) the address of the terminating gatekeeper.

40. A method according to claim 38 and further comprising:
a terminal sending a call termination request to said local gateway;
said local gateway connecting to either of said local gatekeeper and said remote gatekeeper and forwarding said call termination request thereto; and
said remote gatekeeper effecting said call termination via said reserved telephone line at said remote gateway.

41. A method according to claim 30 wherein said notifying step e) comprises said remote gatekeeper providing to said local gatekeeper 1) the network address of said remote gateway, 2) the number of said telephone lines that have been reserved for said local gatekeeper at said remote gateway, and 3) the actual reservation period for each of said reserved telephone lines.

42. A method according to claim 30 wherein said notifying step e) comprises said remote gatekeeper providing to said local gatekeeper 1) the number of said telephone lines that have been reserved for said local gatekeeper and 2) the actual reservation period for each of said reserved telephone lines.

43. A method according to claim 42 wherein said notifying step e) further comprises said remote gatekeeper providing to said local gatekeeper 3) the address of the terminating gatekeeper.

44. A method according to claim 42 and further comprising:
a terminal sending a call termination request to said local gateway;
said local gateway connecting to either of said local gatekeeper and said remote gatekeeper and forwarding said call termination request thereto; and
said remote gatekeeper effecting said call termination via said reserved telephone line at said remote gateway.
